(19) United States
(12) Patent Application Publication
(10) Pub. No.: US 2020/0025927 A1
(43) Pub. Date: Jan. 23, 2020

(54) SYSTEM AND METHOD FOR HIGH-ASSURANCE, HIGH-ACCURACY POSITIONING USING RANGING OF SATELLITES

(71) Applicant: The United States of America as represented by the Secretary of the Navy, San Diego, CA (US)

(72) Inventor: Phillippe Lyles Winters Reed, Charleston, SC (US)

(73) Assignee: The United States of America as represented by the Secretary of the Navy, San Diego, CA (US)

(21) Appl. No.: 16/280,264

(22) Filed: Feb. 20, 2019

Related U.S. Application Data
(63) Continuation-in-part of application No. 14/848,626, filed on Sep. 9, 2015, now Pat. No. 10,254,392.

(51) Int. Cl. G01S 17/74; H04B 10/50; H04B 10/66; G01S 17/88

(52) U.S. Cl. CPC G01S 17/74; G01S 17/88; H04B 10/66; H04B 10/505

(57) ABSTRACT

A method to calculate position comprising the steps of creating a positioning system, wherein the positioning system comprises at least one satellite, at least one user, and at least one fixed ground site, and wherein the at least one satellite is coupled to a modulating retroreflector and a laser communications receiver, and wherein the at least one user comprises a space object tracking lidar system and a laser communications receiver, and wherein the at least one fixed ground site comprises a space object tracking lidar system and a laser communications transmitter and is configured to determine range and range rate to the modulating retroreflector; using the range and range rate to update the fixed ground site's estimate of a satellite ephemeris; configuring the at least one fixed ground site to use the laser communications transmitter to uplink the ephemeris to the at least one satellite's laser communications receiver; recording the ephemeris into the at least one satellite and replace ephemeris previously stored in the at least one satellite; allowing the at least one user to illuminate the at least one satellite's modulating retroreflector using the laser transmitter: using the modulating retroreflector to modulate the updated ephemeris data onto a laser beam, and reflect the modulated signal back to the user; allowing the user to receive and demodulate the laser signal using the laser communications receiver, allowing the user to measure the range and range-rate of the at least one satellite using the space object tracking lidar system; allowing the user to estimate its position using the range, range-rate, and ephemeris.

### CROSS-REFERENCE TO RELATED APPLICATIONS

This application is a continuation-in-part of U.S. patent application Ser. No. 14/848,626, filed on Sep. 9, 2015, entitled “Reverse Ephemeris Method for Determining Position, Attitude, and Time,” the entire content of which is fully incorporated by reference herein.

### FEDERALLY-SPONSORED RESEARCH AND DEVELOPMENT

The System and Method for High-Assurance, High-Accuracy Positioning Using Ranging of Satellites is assigned to the United States Government and is available for licensing for commercial purposes. Licensing and technical inquiries may be directed to the Office of Research and Technical Applications, Space and Naval Warfare Systems Center, Atlantic, Code 72000; voice (843) 218-3495; ssc_lant_t2@navy.mil. Reference Navy Case Number 110244.

### BACKGROUND

Current reverse-ephemeris positioning systems address limitations in existing navigation systems, such as jamming, spoofing, or other interference. Those systems provide a means for a user (a platform on which a radar or lidar system is installed) to measure range and/or range-rate to one or more satellites in known orbits. However, the disadvantages of those systems are that the errors in expected spacecraft position and velocity dominate the error in the position fix, and those spacecraft position and velocity errors get worse the longer the user goes without an update to the spacecraft ephemeris. Even if those systems could measure the precise range of a satellite to within one centimeter and had knowledge of the spacecraft ephemeris, the theoretical expected timing accuracy would only be on the order of 1 microsecond. This is a limitation of the speed of the spacecraft in orbit and the resolution of the ranging system. A need exists for a global positioning system (GPS)-independent positioning, navigation, and timing (PNT) system that can provide high accuracy position and timing data to a user.

### BRIEF DESCRIPTION OF THE DRAWINGS

FIG. 1 shows a diagram of a positioning system 100 that provides a position determination for an indefinite amount of time, with resistance to jamming, spoofing, and interference.

FIG. 2 shows a flow-chart for using a positioning system to provide an accurate position determination for an indefinite amount of time, with increased resistance to jamming, spoofing, and interference.

FIG. 3 shows a diagram of an aerial side view of a positioning system in accordance with the system and method for high-assurance, high-accuracy positioning using ranging of satellites.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment,” “in some embodiments,” and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

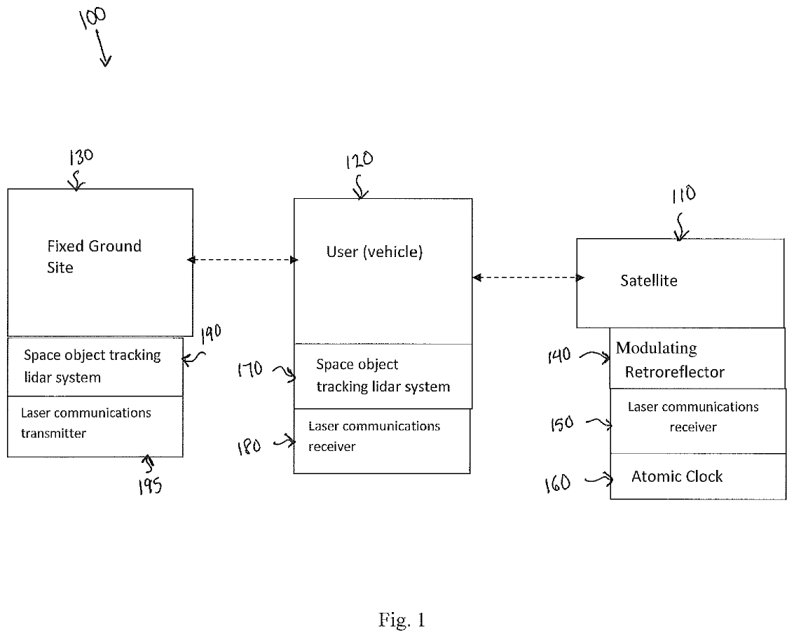

FIG. 1 shows a positioning system 100 that provides a position determination for an indefinite amount of time, with resistance to jamming, spoofing, and interference. Positioning system 100 comprises at least one satellite 110, at least one user 120, and at least one fixed ground site 130. Satellite 110 is equipped with at least one modulating retroreflector 140 and at least one laser communications receiver 150. Satellite 110 may also be equipped with an atomic clock 160.

A modulating retroreflector is a device that can modulate a signal onto an incoming non-modulated electromagnetic wave (e.g. a continuous laser) and send it back to its source. For example, a simple “corner cube” of three orthogonal plates made of reflective material will retro-reflect light back toward its source, regardless of the incoming angle of the light source. A modulating retroreflector incorporates an optical modulator to modulate the intensity of the retro-reflected laser beam before it returns to the source. In this way, the pointing and power requirements of the modulating retroreflector are much less stringent than for an active laser source, which would have to be very accurately aligned toward the distant receiver to be able to close the link. This is particularly useful for ground to space communications applications, as it provides a way to reduce the size, weight, power, and pointing requirements at the spacecraft, and the user on the ground (or ship, aircraft, etc.) hosts the high-power laser source and high accuracy pointing mechanism.

Turning back to FIG. 1, user 120 is equipped with a space object tracking lidar system 170 and a laser communications receiver 180. Fixed ground site 130 is also equipped with a space object tracking lidar system 190 and a laser communications transmitter 195. For positioning system 100, fixed ground site 130 will use lidar system 190 to track and determine range and/or range rate to one or more modulating retroreflector satellites 110. Fixed ground site 130 will use this information to update its estimate of a spacecraft ephemeris (for example, using least-squares differential correction or other means).

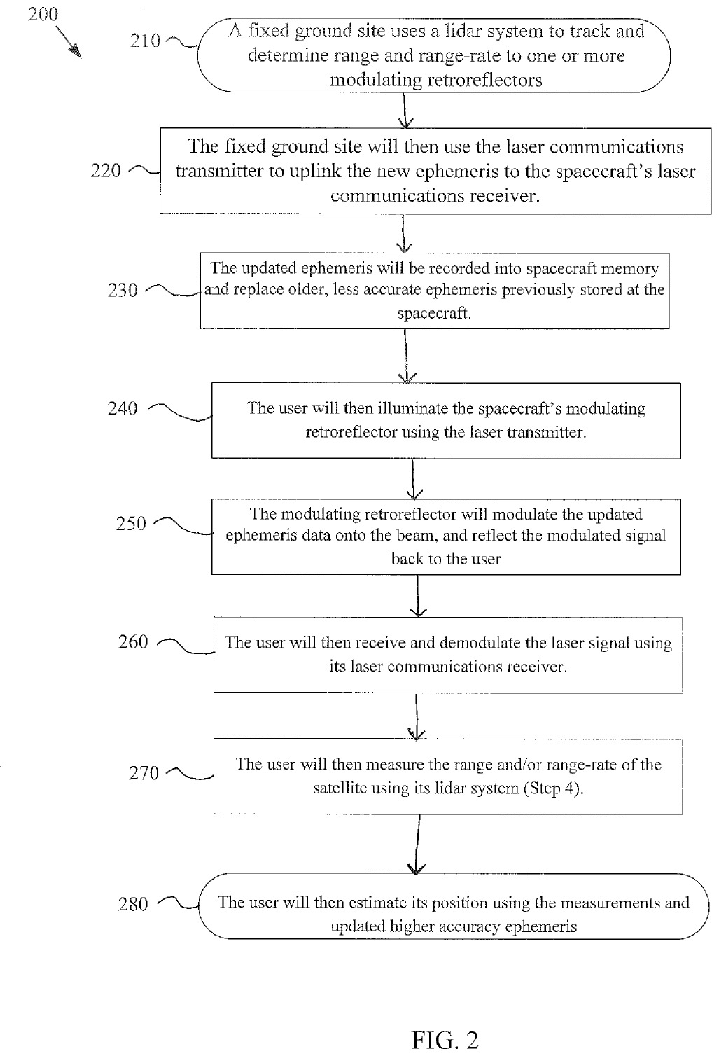

FIG. 2 shows a method 200 for using a positioning system to provide an accurate position determination for an indefinite amount of time, with increased resistance to jamming, spoofing, and interference. In first step 210, a fixed ground site uses a lidar system to track and determine the range and range rate to one or more modulating retroreflector satellites. A positioning system will use the range and range rate to update its estimate of a spacecraft ephemeris, for example, using least-squares differential correction or other means. In second step 220, on the same pass of the satellite overhead, or on a future pass, the ground system will then use the laser communications transmitter to uplink the new ephemeris to the spacecraft's laser communications receiver. In step 230, this information will be recorded into spacecraft memory and replace older, less accurate ephemeris previously stored at the spacecraft. Steps 220 and 230 could be performed simultaneously if the lidar system and laser communications system are entirely separate and do not rely on the same components or electronics at the same time.

For step 240, the user will then illuminate the spacecraft's modulating retroreflector using the laser transmitter. This laser transmitter only needs to transmit a continuous wave signal. No communications waveform is needed because the modulating retroreflector adds that communications modulation onto the continuous wave. For step 250, the modulating retroreflector will modulate the updated ephemeris data onto the beam, and reflect the modulated signal back to the user. For step 260, the user will then receive and demodulate the laser signal using its laser communications receiver. For step 270, the user will then measure the range and/or range-rate of the satellite using its lidar system. Finally, for step 280, the user will then estimate its position using the measurements and updated higher accuracy ephemeris. This system would significantly reduce the primary source of error in the spacecraft ephemeris as it is known to the user, since updated spacecraft ephemeris could be sent directly to the user over the same signal the user transmits. It will also prevent the steady decrease in accuracy over time that would be experienced if the user simply stored a fixed set of ephemeris for the satellite(s).

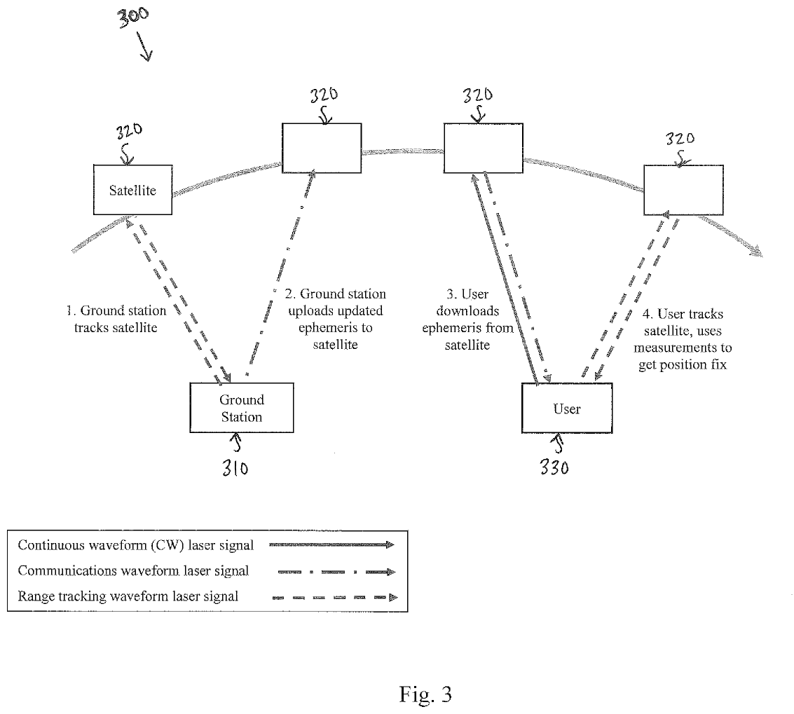

FIG. 3 shows a diagram of aerial side view of a positioning system 300. System 300 has a fixed ground station 310 that tracks a satellite 320 using a range tracking waveform laser signal. Ground station 310 uploads updated ephemeris to satellite 320 using a communications waveform laser signal. A user 330, that is not at a fixed location such as a ship, airplane, or other vehicle, downloads the ephemeris from satellite 320 using a communications waveform laser signal. User 330 then tracks satellite 320 using a range tracking waveform laser signal, and uses measurements to get position fix.

The system and method described herein are a combination of space object tracking lidar systems and modulating retroreflector spacecraft payloads in such a way that the overall system can provide much more accurate position fixes to a user. The use of a second lidar system as a ground station at a known location allows for more accurate and timely determination of the spacecraft ephemeris. The use of a modulating retroreflector on a satellite allows for much less complex, smaller, and more cost-effective satellites. The modulating retroreflector satellite payload allows for ephemeris data, stored after the uplink from the ground station, to be relayed to the user without the need for a high power laser on the satellite or high-accuracy pointing of the satellite.

In an alternate embodiment, the ground sites would track additional satellites (not just modulating retroreflector satellites), and upload the additional satellite ephemeris to the modulating retroreflector satellite, for later downlink by the user to allow the user to attain higher accuracy if tracking those satellites. This would allow for a more diverse set of space objects that could be used, and allow for fewer required modulating retroreflector satellites to ensure at least one object is overhead at all times. One challenge with this method would be implementing safeguards preventing accidental damage to optical payloads on other operational satellites. Another complication would be the added data storage capacity required on the modulating retroreflector satellites, and the time required to upload that data to the modulating retroreflector satellites.

In another alternative, the ground site(s) would also transmit other useful information to the satellites, for later downlink by the user. This information may support the navigation system (e.g., information about satellite status, additional satellite ephemeris, etc.) or may be unrelated data that a different party may wish to transmit to the user. This would allow for a communications path that is also resistant to jamming and interference.

Another alternative would use radar or any other part of electromagnetic spectrum instead of lidar, and appropriate transmitters, receivers, modulators, retroreflectors, etc. Depending on the different electromagnetic wavelengths, such a system might be more susceptible to interference or jamming, but might be simpler or less expensive to construct and maintain.

Another alternative would use a mobile site that knows its location (by using GNSS or other means) instead of a fixed site to track the modulating retroreflector satellites, compute their updated ephemeris, and/or transmit that information to the modulating retroreflector satellites.

Another alternative would incorporate the communications and ranging functions into the same electronics and optics system. For instance, the laser modulator might be programmable to alternate between a ranging waveform and a communications waveform. Similarly, the optical receivers and electronics could be housed within the same enclosure and/or split into different optical pathways (e.g., one for measuring time delays for ranging waveforms, one for receiving and demodulating communications waveforms) after receiving the laser beam through the same telescope.

Another alternative would place the different ground system functions in multiple different locations. For instance, one ground station might track the satellite to measure range and/or range-rate, another would compute the updated ephemeris, and another would upload the new ephemeris to the satellite. These different stations would be connected by fiber optic cable or another communications pathway to allow them to transfer relevant information.

Another alternative would transmit data to and from the satellite via a different communications method, such as radio frequencies (RF). This would make the communications feature of the system more vulnerable to detection and jamming or interference, but would allow for a potentially simpler and less expensive overall design.

In another alternative, atomic clocks or other highly stable clocks could be added to the modulating retroreflector satellites. The ground station and/or user laser systems could be made to conduct one-way or two-way time transfer to and from the satellites. This would allow high-accuracy transfer of reference time to the satellite from the ground station. The satellite would synchronize its atomic clock to the reference time, allowing it to maintain time to a high degree of accuracy for much longer. The satellite would then conduct time transfer with the user, allowing the user to update its clock to a much more accurate approximation of the master time kept at the ground station. This alternative would also increase the positioning accuracy, as timing error is one source of inaccuracy in the positioning system. To keep the satellite system less complex, bulky, or expensive, newly developed chip-scale atomic clocks could be used, albeit with a slight reduction in accuracy over traditional atomic clocks.

In another alternative, much larger, more expensive satellites could be employed. These larger satellites might host traditional atomic clocks for high accuracy time transfer. They might incorporate active laser transmitters and high-accuracy attitude determination and control systems to point at the user. They might also incorporate more exquisite optical systems for beam steering to compensate for spacecraft movement. Such systems would require that the satellites (or their operators) have a priori knowledge of the user position to enable to them to point correctly. Alternatively, they may be able to conduct a search pattern to identify a beacon or laser transmission from the user.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method to calculate position comprising the steps of:
creating a positioning system, wherein the positioning system comprises at least one satellite, at least one user, and at least one fixed ground site, and wherein the at least one satellite is coupled to a modulating retroreflector and a laser communications receiver, and wherein the at least one user comprises a space object tracking lidar system and a laser communications receiver, and wherein the at least one fixed ground site comprises a space object tracking lidar system and a laser communications transmitter and is configured to determine range and range rate to the modulating retroreflector;
using the range and range rate to update the fixed ground site's estimate of a satellite ephemeris;
configuring the at least one fixed ground site to use the laser communications transmitter to uplink the ephemeris to the at least one satellite's laser communications receiver;
recording the ephemeris into the at least one satellite and replace ephemeris previously stored in the at least one satellite;
allowing the at least one user to illuminate the at least one satellite's modulating retroreflector using the laser transmitter;
using the modulating retroreflector to modulate the updated ephemeris data onto a laser beam, and reflect the modulated signal back to the user;
allowing the user to receive and demodulate the laser signal using the laser communications receiver,
allowing the user to measure the range and range-rate of the at least one satellite using the space object tracking lidar system;
allowing the user to estimate its position using the range, range-rate, and ephemeris.

2. The method of claim 1, further comprising the step of allowing the ground site to track a plurality of satellites and upload the corresponding ephemeris to the modulating retroreflector satellite.

3. The method of claim 2, further comprising the step of allowing the ground site to transmit additional information to the at least one satellite for later download by the at least one user.

4. The method of claim 1, further comprising the step of coupling an atomic clock to the at least one satellite.

5. The method of claim 4, further comprising the step of synching the atomic clock to a reference time.

6. A system for calculating position comprising:
at least one satellite coupled to a modulating retroreflector and a laser communications receiver;
at least one fixed ground site comprising a space object tracking lidar system and a laser communications transmitter, wherein the at least one fixed ground site is configured to determine range and range-rate to the modulating retroreflector and transmit the range and range-rate to the laser communications receiver;
at least one user comprising a space object tracking lidar system and a laser communications receiver, wherein the at least one user is configured to illuminate the modulating retroreflector causing the range and range-rate to be reflected back to the user, and wherein the user is configured to estimate its position.

7. The system of claim 6, further comprising an atomic clock coupled to the at least one satellite.

8. The system of claim 6, further comprising a chip-scale atomic clock coupled to the at least one satellite.

9. The system of claim 6, wherein the user is a ship.

10. The system of claim 6, wherein the user is an aircraft.

11. The system of claim 6, wherein the user is a submarine.

12. A method for determining position comprising the steps of:
using a fixed ground site comprising a lidar system and a laser communications transmitter to track and determine range and range-rate to a modulating retroreflector, wherein the modulating retroreflector is coupled to a satellite;
using the range and range-rate to update an estimate of the satellite ephemeris;
using the laser communications transmitter to uplink the range and range-rate to the satellite, wherein the satellite further comprises a laser communications receiver;
allowing a portable user to illuminate the modulating retroreflector using the laser transmitter, wherein the portable user comprises a laser communications receiver;
allowing the modulating retroreflector to modulate the satellite ephemeris onto a laser beam and reflecting the satellite ephemeris-encoded laser beam back to the user;
allowing the portable user to receive and demodulate the satellite ephemeris data using its laser communications receiver;
allowing the user to measure the range and range-rate of the satellite using its lidar system;
allowing the user to estimate its position.
